(19) United States
(12) Patent Application Publication
(10) Pub. No.: US 2025/0083436 A1
(43) Pub. Date: Mar. 13, 2025

(54) AUTOMATIC INKER FOUNTAIN COLOR DETECTION AND ERROR CORRECTION SYSTEM AND METHOD

(71) Applicant: Stolle Machinery Company, LLC, Centennial, CO (US)

(72) Inventor: Sayon Chandrakanthan, Lakewood, CO (US)

(73) Assignee: Stolle Machinery Company, LLC, Centennial, CO (US)

(21) Appl. No.: 18/823,767

(22) Filed: Sep. 4, 2024

Related U.S. Application Data
(60) Provisional application No. 63/537,285, filed on Sep. 8, 2023.

(51) Int. Cl. B41F 33/00; B41F 17/22; B41M 1/40; G01J 3/50; G06K 15/02; G06T 7/00; G06T 7/90

(52) U.S. Cl. CPC B41F 33/0045; B41F 17/22; B41M 1/40; G01J 3/50; G06K 15/021; G06T 7/0004; G06T 7/90; G06T 2207/10024; G06T 2207/30144

(57) ABSTRACT

An automatic inker fountain color detection and error correction system includes: a can decorator including a plurality of inking stations each including inker fountains; a plurality of color sensors each disposed in vicinity of respective inker fountains and structured to detect ink colors of inks placed in the inker fountains; a vision sensor disposed at an output of the can decorator and structured to capture images of printed cans; and an automatic inker fountain color detection and error correction device communicatively coupled to the plurality of color sensors, the vision sensor, and the inking stations, and structured to receive the ink color information from the color sensors and the captured images from the vision sensor, determine that an inker fountain color error has occurred based on the captured images and correct the inker fountain color error based at least in part on the ink color information.

### CROSS REFERENCE TO RELATED APPLICATIONS

This application claims priority to U.S. Provisional Patent Application Ser. No. 63/537,285, filed Sep. 8, 2023, entitled, AUTOMATIC INKER FOUNTAIN COLOR DETECTION AND ERROR CORRECTION SYSTEM AND METHOD, which is incorporated herein by reference in its entirety.

### FIELD OF THE INVENTION

The disclosed concept relates generally to an apparatus, system and method for decorating cans using a can decorator and, more particularly, to an automatic inker fountain color detection and error correction system and method for use with the can decorator.

### BACKGROUND OF THE INVENTION

High speed continuous motion machines for decorating cans, commonly referred to as “can decorator machines” or simply “can decorators,” are generally well known. FIG. 1 shows a can decorator 2. As shown in FIG. 1, a can decorator 2 includes an infeed conveyor 15, which receives cans 16 from a can supply (not shown) and directs them to arcuate cradles or pockets 17 along the periphery of spaced parallel rings secured to a pocket wheel 12. The pocket wheel 12 is fixedly secured to a continuously rotating mandrel carrier wheel 18, which in turn is keyed to a continuously rotating horizontal drive shaft 19. Horizontal spindles or mandrels (not shown), each being pivotable about its own axis, are mounted to the mandrel carrier wheel 18 adjacent its periphery. Downstream from the infeed conveyor 15, each spindle or mandrel is in closely spaced axial alignment with an individual pocket 17, and undecorated cans 16 are transferred from the pockets 17 to the mandrels. Suction applied through an axial passage of the mandrel draws the can 16 to a final seated position on the mandrel.

While mounted on a mandrel, each can 16 is decorated by being brought into engagement with a blanket (e.g., without limitation, a replaceable adhesive-backed piece of rubber) disposed on a blanket wheel of the multicolor printing unit indicated generally by reference numeral 22. Thereafter, and while still mounted on the mandrels, the outside of each decorated can 16 is coated with a protective film of varnish applied by engagement with the periphery of a varnish applicator roll (not shown) rotating on a shaft 23 in the overvarnish unit indicated generally by reference numeral 24. Cans 16 with decorations and protective coatings thereon are then transferred from the mandrels to suction cups (not shown) mounted adjacent the periphery of a transfer wheel (not shown) rotating on a shaft 28 of a transfer unit 27. From the transfer unit 27 the cans 16 are deposited on generally horizontal pins 29 carried by a chain-type output conveyor 30, which carries the cans 16 through a curing oven (not shown).

While moving toward engagement with an undecorated can 16, the blanket wheel engages a plurality of plate cylinders 31, each of which is associated with an individual inking station 32 (an exemplary eight inking stations 32 are shown in FIG. 1). The plurality of plate cylinders 31 and the inking stations 32 place a label on a can 16 based on a specification from a vendor. Typically, each inking station 32 provides a different color ink and each plate cylinder 31 applies a different ink image segment to the blanket. All of the “ink image” segments combine to produce a “main image” (i.e., a label) that is structured to be applied to the can body. The “main image” is then transferred to undecorated cans 16 and becomes, as used herein, the “can body applied image.”

Each inking station 32 includes a plurality of rollers, or as used herein, “rolls,” that are structured to transfer a quantity of ink from a reservoir, or as used herein an “ink fountain,” to the blanket. The path that the ink travels is, as used herein, identified as the “ink train.” That is, the rolls over which the ink travels define the “ink train.” Further, as used herein, the “ink train” has a direction with the inker fountain 33 (as shown in FIG. 3) being at the “upstream” end of the ink train and a plate cylinder 31 at the “downstream” end of the ink train.

The ink train extends over a number of rolls each of which has a purpose. As shown, the ink train starts at the ink fountain and is initially applied as a film to a fountain roll. The fountain roll is intermittently engaged by a ductor roll. When the ductor roll engages the fountain roll, a quantity of ink is transferred to the ductor roll. The ductor roll also intermittently engages a downstream roll and transfers ink thereto. The ductor roll has a “duty cycle” which, as used herein, means the ratio of the duration of the ductor roller being in contact with the fountain roller divided by the duration of a complete cycle (ductor roller in contact with the fountain roller, move to the first downstream roller, contact with first steel roller, move back to fountain roller).

The other rolls include, but are not limited to, distribution roll(s), oscillator roll(s), and transfer roll(s). Generally, these rolls are structured to distribute the ink so that a proper amount of ink is generally evenly applied to the plate cylinder 31. For example, the oscillator rolls are structured to reciprocate longitudinally about their axis of rotation so as to spread the ink as it is applied to the next downstream roll. The final roll is the plate cylinder 31 which applies the ink to the blanket. It is understood that each inking station 32 applies an “ink image” of a single selected color to the blanket and that each inking station 32 must apply the ink image in a proper position relative to the other ink images so that the main image does not have offset ink images.

Thus, as used herein, an “ink image” means the image of a single ink color which is part of a “main image.” As used herein, a “main image” means an image created from a number of ink images and which is the image that is applied to a can body as the “can body applied image.” It is understood that a “main image” includes a number, and typically a plurality, of ink images. For example, if the main image was the French flag (which is a tricolor flag featuring three vertical bands colored blue (hoist side), white, and red), an inking station 32 with blue ink would provide an ink image that is a blue rectangle, an inking station 32 with white ink would provide an ink image that is a white rectangle and an inking station 32 with red ink would provide an ink image that is a red rectangle. Further, presuming that the main image was of a French flag with the hoist side on the left, the inking station 32 with blue ink would provide the blue rectangle ink image on the left side of the blanket, the inking station 32 with white ink would provide the white rectangle ink image on the center of the blanket immediately adjacent the blue rectangle ink image, and the inking station 32 with red ink would provide the red rectangle ink image on the right side of the blanket immediately adjacent the white rectangle ink image. Once all the ink images are applied to the blanket, the main image is formed and then applied to a can body.

Currently, it is difficult to determine if a correct ink color is placed in an inker fountain or if colors from a recipe being restored match ink colors in the inker fountains. For example, when restoring a recipe, all of the colors and key settings from the recipes need to be loaded accurately, e.g., a white ink is loaded in a corresponding inker fountain as indicated in the memory, such that inker keys of inker fountains having the right color inks are adjusted to setpoints for respective hues required by the recipe. Often, an ink color indicated as being placed in one inker fountain may not be in the indicated inker fountain, e.g., placed in a different inker fountain or missing. That is, a white ink indicated to be placed in an inker fountain three may be placed in an inker fountain five and another color ink, e.g., without limitation, a black ink may be placed in the inker fountain three. An engineer adjusting setpoints for inker keys for the white as per the recipe may not be aware of this discrepancy and adjust the setpoints for the inker keys for the inker fountain three, resulting in adjusting the setpoints for the inker fountain having the black ink. As such, the engineer does not realize the discrepancy in the ink color placement until reviewing the images captured by a vision sensor, the images showing the black ink having been printed in the area in which the white ink should have been printed. To make the matters worse, the engineer still remains blinded as to which inker fountain includes the white ink or if the white ink is even included in any of inker fountains. In order to determine the current ink color placements, the engineer either needs to stop the printing and dispatch an operator to the field to find out where the white ink is placed or switch to a different operation from printing during such determination. The operator then checks the inker fountains and enters the colors of inks associated with the inker fountain into a work station. The printing can only resume after determining the current ink color placements. Such manual inker color detection and error correction process and resultant intermissions between printing not only waste time, but also result in business losses.

There is room for improvement in printing during the can manufacturing process.

There is a need for improved detection and error correction of inker fountain color errors during can decorating.

### SUMMARY OF THE INVENTION

These needs, and others, are met by an automatic inker fountain color detection and error correction system that comprises: a can decorator including a plurality of inking stations each including inker fountains; a plurality of color sensors each disposed in vicinity of respective inker fountains and structured to detect ink colors of inks placed in the inker fountains; a vision sensor disposed at an output of the can decorator and structured to capture images of printed cans; and an automatic inker fountain color detection and error correction device comprising a memory having previous adjustment information and communicatively coupled to the plurality of color sensors, the vision sensor, and the inking stations, the automatic inker fountain color detection and error correction device being structured to receive the ink color information from the color sensors and the captured images from the vision sensor, determine that an inker fountain color error has occurred based on the captured images and correct the inker fountain color error based on at least one of the ink color information and the previous adjustment data.

Another embodiment provides a method of automatic inker fountain color. detection and correction. The method includes: providing an automatic inker fountain color detection and error correction system that comprises: (i) a can decorator including a plurality of inking stations each including inker fountains; (ii) a plurality of color sensors each disposed in vicinity of respective inker fountains and structured to detect ink colors of inks placed in the inker fountains; (iii) a vision sensor disposed at an output of the can decorator and structured to capture images of printed cans; and (iv) an automatic inker fountain color detection and error correction device comprising a memory having previous adjustment information and communicatively coupled to the plurality of color sensors, the vision sensor, and the inking stations, the automatic inker fountain color detection and error correction device being structured to receive the ink color information from the color sensors and the captured images from the vision sensor, determine that an inker fountain color error has occurred based on the captured images and correct the inker fountain color error based on at least one of the ink color information and the previous adjustment data. The method further includes detecting, by the color sensors, ink colors of inks placed in the inker fountains and transmitting ink color information to the automatic inker fountain color detection and error correction device; printing cans based on a recipe; capturing first image of first printed cans at the output of the can decorator and transmitting the first image to the automatic inker fountain color detection and error correction device; determining that an inker fountain color error has occurred based on the first image; and correcting the inker fountain color error based on at least one of the ink color information and the previous adjustment information.

### BRIEF DESCRIPTION OF THE DRAWINGS

A full understanding of the invention can be gained from the following description of the preferred embodiments when read in conjunction with the accompanying drawings in which:

FIG. 1 is an exemplary can decorator;

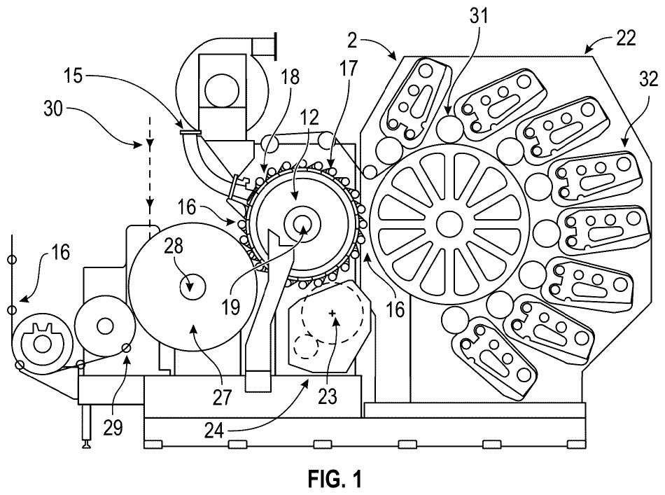

FIG. 2 is an exemplary automatic inker fountain color detection and error correction system according to a non-limiting, example embodiment of the disclosed concept;

FIG. 3 is a schematic diagram of an inking station having an inker fountain and a roller assembly with a corresponding ink color sensor in accordance with a non-limiting, example embodiment of the disclosed concept; and

FIG. 4 is a flow chart for a method of automatic inker fountain color detection and error correction system registration and color adjustment according to a non-limiting, example embodiment of the disclosed concept.

### DETAILED DESCRIPTION OF THE INVENTION

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together or act upon/with each other in some manner. For example, an automobile has four tires and four hub caps. While all the elements are coupled as part of the automobile, it is understood that each hubcap is “associated” with a specific tire.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. As used herein, “adjustably fixed” means that two components are coupled so as to move as one while maintaining a constant general orientation or position relative to each other while being able to move in a limited range or about a single axis. For example, a doorknob is “adjustably fixed” to a door in that the doorknob is rotatable, but generally the doorknob remains in a single position relative to the door. Further, a cartridge (nib and ink reservoir) in a retractable pen is “adjustably fixed” relative to the housing in that the cartridge moves between a retracted and extended position, but generally maintains its orientation relative to the housing. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the statement that two or more parts or components “engage” one another means that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, the term “number” shall mean one or an integer greater than one (i.e., a plurality). That is, for example, the phrase “a number of elements” means one element or a plurality of elements. It is specifically noted that the term “a ‘number’ of [X]” includes a single [X].

As used herein, “about” in a phrase such as “disposed about [an element, point or axis]” or “extend about [an element, point or axis]” or “[X] degrees about an [an element, point or axis],” means encircle, extend around, or measured around. When used in reference to a measurement or in a similar manner, “about” means “approximately,” i.e., in an approximate range relevant to the measurement as would be understood by one of ordinary skill in the art.

As used herein, an “elongated” element inherently includes a longitudinal axis and/or longitudinal line extending in the direction of the elongation.

As used herein, “generally” means “in a general manner” relevant to the term being modified as would be understood by one of ordinary skill in the art.

As used herein, “substantially” means “for the most part” relevant to the term being modified as would be understood by one of ordinary skill in the art.

As used herein, “at” means on and/or near relevant to the term being modified as would be understood by one of ordinary skill in the art.

Example embodiments of the disclosed concept provide an automatic inker fountain color detection and error correction system and method thereof. The automatic inker fountain color detection and error correction system automatically detects the colors of inks placed in inker fountains by color sensors, detect any inker fountain color error based on images captured by a vision sensor and corrects the inker fountain color error based on the detection of the colors of the inks placed in inker fountains. The automatic inker fountain color detection and error correction system allows streamlined printing based on automatically detected ink colors placed in inker fountains by the color sensors and images of printed cans captured by a vision sensor. Especially, in a closed loop environment in which a recipe is restored, ink colors and inker key setpoints are set for printing and the can quality is determined based on a vision sensor output of printed cans, it is important to know correct ink color placement information associated with inker fountains. By utilizing a color sensor for each inker fountain that can detect ink color therein at any given time, the automatic inker fountain color detection and error correction system allows the engineer to know what color ink is placed in which inker fountain and/or which color ink may be missing. Further, in case the current color placement has not been reviewed before printing, the automatic inker fountain color detection and error correction system can automatically and immediately correct the inker fountain color error immediately upon detection of the inker fountain color error, thereby significantly reducing any time expended for manually detecting and correcting the inker fountain color errors on site. Further, the automatic inker fountain color detection and error correction system advantageously allows expeditious collection of data and efficient application of the data collected. For example, if the engineer is aware of correct ink color placement, any time wasted in collecting incorrect data on incorrect ink color can be eliminated. Further, when a recipe requires a specific hue of an ink color prompting adjustments of setpoints for inker keys, an engineer at a remote location can review previous adjustment information collected and determine an appropriate adjustment that can satisfy the recipe requirements based on the previous adjustment information immediately. That is, if the vision sensor captures an image including a faded ink color, the engineer may review and find an appropriate adjustment required for the inker keys based on the previous adjustment information. For instance, the previous adjustment information may indicate, e.g., moving an inker key 10% closer to a roller provides the ink hue required by the recipe. As such, by providing the ability to automatically detect colors of inks placed in inker fountains at all times by the color sensors allows the engineer to apply the collected data accurately without wasting time, thereby significantly expediting the can printing process.

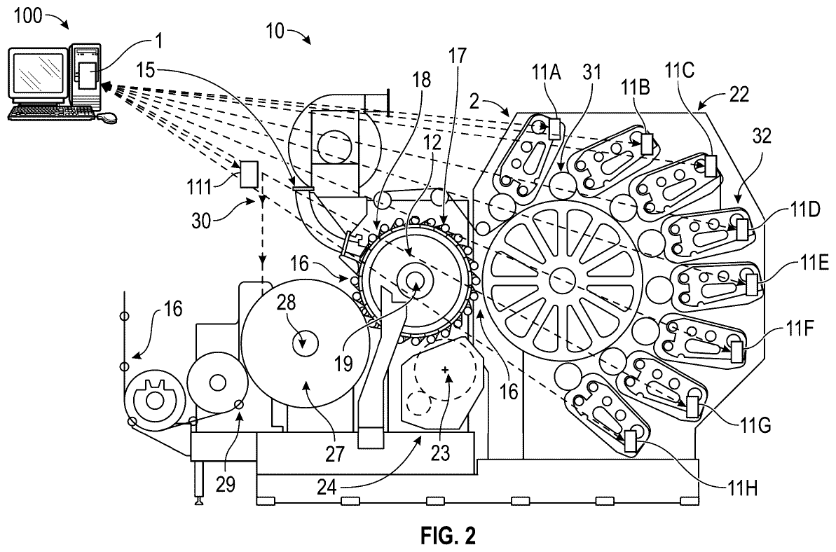

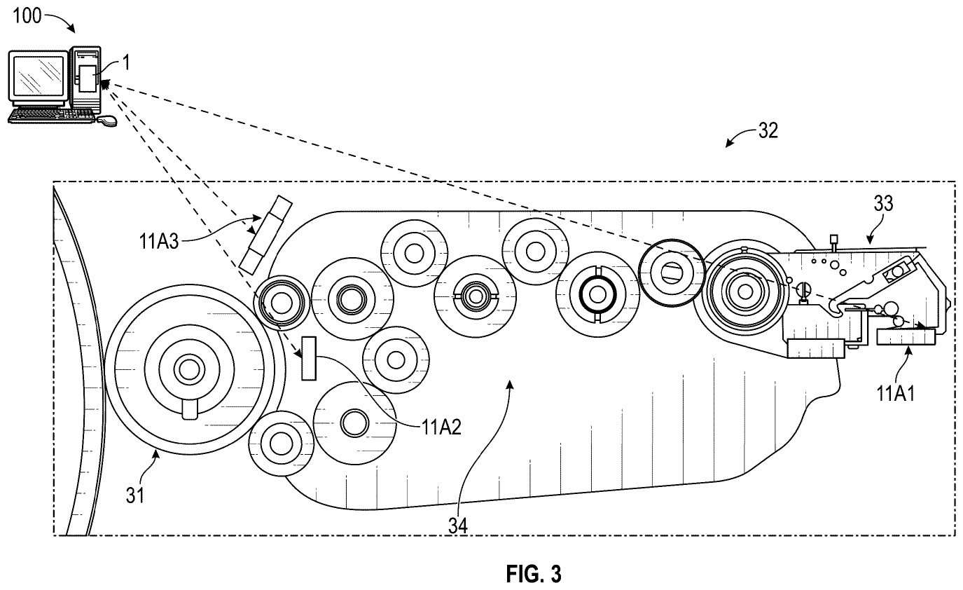

FIG. 2 illustrates an automatic inker fountain color detection and error correction system 10 in accordance with a non-limiting, example embodiment of the disclosed concept. FIG. 3 is a schematic diagram of an inking station 32 having an inker fountain 33 and a roller assembly 34, each inker fountain 33 including a color sensor 11, each inking station 32 associated with a plate cylinder 31 in accordance with a non-limiting, example embodiment of the disclosed concept. The automatic inker fountain color detection and error correction system 10 is described with reference to FIGS. 2-3. The automatic inker fountain color detection and error correction system 10 includes a can decorator 2 including a plurality of inking stations 32 each including inker fountains 33, a plurality of color sensors 11A-H each disposed in vicinity of respective inker fountains 33 and structured to detect ink color of inks placed in the inker fountains 33; a vision sensor 111 disposed at an output of the can decorator 2 and structured to capture images of printed cans 16; and an automatic inker fountain color detection and error correction device 1 communicatively coupled to the plurality of color sensors 11A-H, the vision sensor 111, and the inking stations 32, the automatic inker fountain color detection and error correction device 1 comprising a memory including previous adjustment data and being structured to receive the ink color information from the color sensors 11A-H and the captured images from the vision sensor 111, determine that an inker fountain color error has occurred based on the captured images, and correct the inker fountain color error based on at least one of the ink color information and the previous adjustment information.

Each color sensor 11A-H is disposed in the vicinity of each inker fountain 33 and structured to detect ink color placed in respective inker fountain 33 and transmit ink color information to the automatic inker fountain color detection and error correction device 1. It may be disposed at various location in the vicinity of the inker fountain 33 and/or the inking station 32 as shown in FIG. 3. FIG. 3 shows a color sensor 11A1 being disposed on the inker fountain 33, a color sensor 11A2 disposed on the inking station 32 and adjacent to one or more rollers 34, and a color sensor 11A3 disposed adjacent to the inking station 32. As such, a color sensor 11A-H may be disposed in or in vicinity of respective inker fountain 33 as appropriate to detect the color of the ink placed in the respective inker fountain 33. A color sensor 11A-H may be, e.g., without limitation, optical fiber color sensors such as thrubeam or reflective sensor, or other color monitoring devices using different communication methods such as ethernet IP, canbus, modbus, IO-Link, etc.

A vision sensor 111 is disposed at an output (e.g., without limitation, near a chain-type output conveyor 30) of the can decorator 2 and structured to capture an image of a printed can 16 and transmit the image to the automatic inker fountain color detection and error correction device 1. The vision sensor 111 includes a plurality of cameras for capturing 3600 images of the printed cans 16.

The automatic inker fountain color detection and error correction device 1 is disposed in a workstation 100 for controlling the operations of the can decorator 2 and structured to receive the ink color information and the captured image, determine if there is an inker fountain color error (e.g., without limitation, an ink color being placed in an incorrect inker fountain, an ink color being faded, etc.) based on the captured image and corrects the inker fountain color error based on at least one of the ink color information and the previous adjustment information. The workstation 100 may be, e.g., without limitation, a computer, a workstation, etc. disposed in vicinity of the can decorator 2. While FIGS. 2 and 3 illustrate the automatic registration and color adjustment device 1 disposed within the workstation 100, it will be appreciated that the automatic inker fountain color detection and error correction device 1 may be a standalone device, e.g., without limitation, a PC or workstation solely structured to automatically detect inker fountain color and correct inker fountain color errors without departing from the scope of the disclosed concept.

The automatic inker fountain color detection and error correction device 1 may be, for example and without limitation, a microprocessor, a microcontroller, or some other suitable processing device or circuitry. It may include memory, which can be any of one or more of a variety of types of internal and/or external storage media such as, without limitation, RAM, ROM, EPROM(s), EEPROM(s), FLASH, and the like that provide a storage register, i.e., a machine readable medium, for data storage such as in the fashion of an internal storage area of a computer, and can be volatile memory or nonvolatile memory. The memory includes instructions or codes for performing the automatic inker fountain color detection and error correction device 1 operations. It is structured to also store ink color placement information in inker fountains 33 and current and previous adjustment information. The previous adjustment information is collected and stored over a predefined period, e.g., without limitation, at least a day, and updated continuously by the automatic inker fountain color detection and error correction device 1. The previous adjustment information includes a specific inker key setpoints change, associated captured images triggering the setpoints change, effects of the specific inker key setpoints change on ink color on printed cans, and correlation data between the specific inker key setpoints change, the associated captured images and the effects thereof. The memory may also include machine learning algorithm configured to train based on the stored data and execute the instructions based on the training.

In operation, when a recipe is being restored, one or more inks are added to inker fountains 33. For example, if the recipe includes a light black image, an ink injector (e.g., Inkjector® of Stolle Machinery Company, LLC, 6949 S. Potomac St., Centennial, CO 80112) of the can decorator 2 sets setpoints for inker keys (not shown) based on the stored ink color placements in the inker fountains 33 and the can decorator 2 starts to print cans 16 using the recipe. That is, if the black ink (a first color ink) is indicated to be placed in a first inker fountain, the ink injector sets setpoints for the inker keys for the first inker fountain and the cans 16 are printed using these setpoints. The color sensors 11A-H detect colors of inks placed in inker fountains 33 and transmit ink color information to the automatic inker fountain color detection and error correction device 1. The ink color information may include standard color information, e.g., CIELAB color spaces, etc., that is understood universally and uniformly such that no confusion of color identification due to different languages or cultures no longer occurs. As such, the automatic inker fountain color detection and error correction system provides a color identification output that is uniformly and universally understood such that the color identification no longer relies on language or culture of an operator of the can decorator.

The vision sensor 111 captures first images of first printed cans 16 at the output of the can decorator 2 and transmits the first images to the automatic inker fountain color detection and error correction device 1. Upon receiving the first images, the automatic inker fountain color detection and error correction device 1 then determines that an inker fountain color error has occurred. An inker fountain color error may include, e.g., without limitation, printing incorrect ink color, incorrect ink hues, etc. In this example, the inker fountain color error may include printing white ink (a second color ink) in the area of the cans 16 designated for the first color ink (black ink). Upon determining that an inker fountain color error has occurred, the automatic inker fountain color detection and error correction device 1 corrects the inker fountain color error based on at least one of the ink color information and the data including the previous adjustment information. For correcting the inker fountain color error, the automatic inker fountain color detection and error correction device 1 may determine that the first color ink is placed in a second inker fountain instead of the first inker fountain, and thus swap the first inker fountain with the second inker fountain. Further, since the recipe requires a light black, the automatic inker fountain color detection and error correction device 1 causes the inking station 32 to be adjusted. That is, the automatic inker fountain color detection and error correction device 1 causes the setpoints of the inker key associated with the first inker fountain to be adjusted based on the previous adjustment data. If the automatic inker fountain color detection and error correction device 1 determines that the first color ink is missing, it may halt the printing process to obtain the first color ink and place it in an empty inker fountain and adjust the inker key associated with the empty inker fountain.

Upon correcting the inker fountain color error, the automatic inker fountain color detection and error correction device 1 confirms that second captured images of second printed cans 16 based on the correction satisfy image requirements of the recipe. The automatic inker fountain color detection and error correction device 1 further collects current data associated with correcting the inker fountain color error, the data including, e.g., without limitation, a specific inker key setpoints change, associated captured images triggering the setpoints change, an effect of the specific inker key setpoints change on ink color on printed cans, and correlation data between the specific inker key setpoints change, the associated captured image and the effect.

Accordingly, the inventive automatic inker fountain color detection and error correction system 1 automates the detecting inker fountain color and correcting inker fountain color error processes, thereby increasing the production output and reducing time and expenses for manually detecting and correcting inker fountain color errors. Further, it allows an automated, expeditious and effective closed loop system between reading the ink colors from the vision sensors 111 and determining that the ink colors satisfy the standard criteria required for the recipe and/or a specification label from a customer so as to ensure no inker fountain color errors occur during printing. In addition, it allows for remote control of the inking station 32 for can decorators located domestically and/or globally, thereby simplifying the can printing process locally and globally and allow allocation of labor and resources to other areas or processes. Moreover, it provides a streamlined data collection and application of the data for colors in recipes. For example, since the automatic inker fountain color detection and error correction device 1 is aware of ink colors of the inks placed in inker fountains 33, it eliminates any time wasted on collecting data of an incorrect ink color. It also no longer needs to stop data collection process for each color for restored recipes in order to manually detect and ensure that the ink for which the data are being collected is placed in the inker fountain as indicated in the memory of automatic inker fountain color detection and error correction device 1. Finally, it also streamlines the printing process. Since the automatic inker fountain color detection and error correction device 1 ensures that the inker fountain 33 including a correct color ink is adjusted, any shut-down periods or diversions to different processes during correction can be averted, thereby completing printing tasks timely.

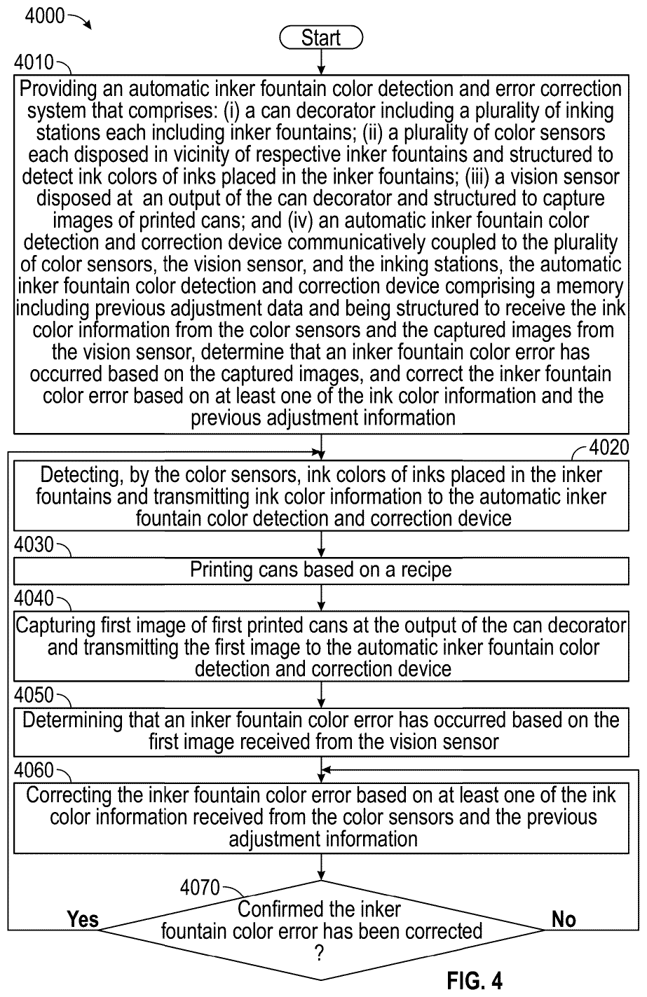

FIG. 4 is a flow chart for a method 4000 of automatic inker fountain color detection and error correction using an automatic inker fountain color detection and error correction system according to a non-limiting, example embodiment of the disclosed concept. The automatic registration and color adjustment system is similar to the automatic registration and color adjustment system 10 as described with reference to FIGS. 2-3. The method 4000 may be performed by the automatic registration and color adjustment system 10 or the components thereof.

At 4010, an automatic inker fountain color detection and error correction system is provided. The automatic inker fountain color detection and error correction system includes: (i) a can decorator including a plurality of inking stations each including inker fountains; (ii) a plurality of color sensors each disposed in vicinity of respective inker fountains and structured to detect ink colors of inks placed in the inker fountains; (iii) a vision sensor disposed at an output of the can decorator and structured to capture images of printed cans; and (iv) an automatic inker fountain color detection and error correction device communicatively coupled to the plurality of color sensors, the vision sensor, and the inking stations, the automatic inker fountain color detection and error correction device comprising a memory including previous adjustment data and being structured to receive the ink color information from the color sensors and the captured images from the vision sensor, determine that an inker fountain color error has occurred based on the captured images, and correct the inker fountain color error based on at least one of the ink color information and the previous adjustment information.

At 4020, the color sensors detect ink colors of inks placed in the inker fountains and transmit ink color information to the automatic inker fountain color detection and error correction device.

At 4030, the can decorator print cans based on a recipe.

At 4040, the vision sensor captures first image of first printed cans at the output of the can decorator and transmits the first image to the automatic inker fountain color detection and error correction device.

At 4050, the automatic inker fountain color detection and error correction device determines that an inker fountain color error has occurred based on the first image.

At 4060, the automatic inker fountain color detection and error correction device corrects the inker fountain color error based on at least one of the ink color information received from the color sensors and data including previous adjustment information.

At 4070, the automatic inker fountain color detection and error correction device confirms that the inker fountain color error has been corrected based on second images received from the vision sensor, the second images including images of second printed cans printed after the correcting. Upon confirmation, the method 4000 proceeds to 4020. If it has not been confirmed that the inker fountain color error has been corrected, the method 4000 proceeds to 4060.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. An automatic inker fountain color detection and error correction system, comprising:
a can decorator including a plurality of inking stations each including inker fountains and structured to print cans based on a recipe;
a plurality of color sensors each disposed in vicinity of respective inker fountains and structured to detect ink colors of inks placed in the inker fountains;
a vision sensor disposed at an output of the can decorator and structured to capture images of printed cans; and
an automatic inker fountain color detection and error correction device communicatively coupled to the plurality of color sensors, the vision sensor, and the inking stations, the automatic inker fountain color detection and error correction device comprising a memory including previous adjustment data and being structured to receive the ink color information from the color sensors and the captured images from the vision sensor, determine that an inker fountain color error has occurred based on the captured images, and correct the inker fountain color error based on at least one of the ink color information and the previous adjustment information.

2. The system of claim 1, wherein the recipe designates a first color ink to be printed in an area of cans and the memory further includes the ink color placement information indicating that the first ink color is placed in a first inker fountain, and wherein the inker fountain color error comprises a second color ink being printed in the area of cans designated for the first color ink.

3. The system of claim 2, wherein for correcting the inker fountain color error, the automatic inker fountain is further structured to swap the first inker fountain with the second inker fountain.

4. The system of claim 3, wherein the recipe designates a specific hue of the first color ink, and wherein for correcting the inker fountain color error, the automatic inker fountain color detection and error correction device 1 is communicatively coupled to inker keys for the inker fountains and further structured to cause setpoints of an inker key associated with the first inker fountain to be adjusted based on the previous adjustment information.

5. The system of claim 4, wherein the previous adjustment information includes a specific inker key setpoints change, associated captured images triggering the setpoints change, effects of the specific inker key setpoints change on ink color on printed cans, and correlation data between the specific inker key setpoints change, the associated captured images and the effects thereof.

6. The system of claim 5, wherein the automatic inker fountain color detection and error correction device is further structured to collect data associated with the correcting the inker fountain color error and store the data in the memory.

7. The system of claim 6, wherein the automatic inker fountain color detection and error correction device is further structured to confirm that the inker fountain color error has been corrected based on second images of second printed cans printed after the correcting.

8. The system of claim 1, wherein the color sensors comprise fiber optic color sensors.

9. The system of claim 1, wherein the vision sensor comprises a plurality of cameras.

10. The system of claim 1, wherein the automatic inker fountain color detection and error correction system allows a closed loop system between reading the ink colors from the images received the vision sensor and determining that the ink colors from the images satisfy recipe criteria without having to manually adjust inking fountains or inker keys.

11. The system of claim 1, wherein the automatic inker fountain color detection and error correction system provides a color identification output that is uniformly and universally understood such that the color identification no longer relies on language of an operator of the can decorator.

12. A method of automatic inker fountain color detection and correction, comprising:
providing an automatic inker fountain color detection and error correction system that comprises: (i) a can decorator including a plurality of inking stations each including inker fountains; (ii) a plurality of color sensors each disposed in vicinity of respective inker fountains and structured to detect ink colors of inks placed in the inker fountains; (iii) a vision sensor disposed at an output of the can decorator and structured to capture images of printed cans; and (iv) an automatic inker fountain color detection and error correction device communicatively coupled to the plurality of color sensors, the vision sensor, and the inking stations, the automatic inker fountain color detection and error correction device comprising a memory including previous adjustment data and being structured to receive the ink color information from the color sensors and the captured images from the vision sensor, determine that an inker fountain color error has occurred based on the captured images, and correct the inker fountain color error based on at least one of the ink color information and the previous adjustment information;
detecting, by the color sensors, ink colors of inks placed in the inker fountains and transmitting ink color information to the automatic inker fountain color detection and error correction device;
printing cans based on a recipe;
capturing, by the vision sensor, first image of first printed cans at the output of the can decorator and transmitting the first image to the automatic inker fountain color detection and error correction device;
determining, by the automatic inker fountain color detection device, that an inker fountain color error has occurred based on the first image received from the vision sensor; and
correcting, by the automatic inker fountain color detection device, the inker fountain color error based on at least one of the ink color information received from the color sensors and the previous adjustment data.

13. The method of claim 12, further comprising:
capturing, by the vision sensor, second images of second printed cans based on the correcting;
receiving, by the automatic inker fountain color detection and error correction device, the second images from the vision sensor; and
confirming, by the automatic inker fountain color detection and error correction device, that the inker fountain color error has been corrected based on the second images.

14. The method of claim 12, wherein the recipe designates a first color ink to be printed in an area of cans and the memory storing color ink placement information associated with the inker fountains, the color ink placement information indicating that the first ink color is placed in a first inker fountain, and wherein the inker fountain color error comprises a second color ink being printed in the area of cans designated for the first color ink.

15. The method of claim 14, wherein the correcting, by the automatic inker fountain color detection and error correction device, comprises:
swapping, by the automatic inker fountain color detection and error correction device, the first inker fountain with the second inker fountain.

16. The method of claim 12, wherein the recipe designates a specific hue of the first color ink, wherein the correcting, by the automatic inker fountain color detection and error correction device, comprises:
causing, by the automatic inker fountain color detection and error correction device, setpoints of an inker key associated with the first inker fountain to be adjusted based on the previous adjustment information.

17. The method of claim 12, wherein the previous adjustment information includes a specific inker key setpoints change, associated captured images triggering the setpoints change, effects of the specific inker key setpoints change on ink color on printed cans, and correlation data between the specific inker key setpoints change, the associated captured images and the effects thereof.

18. The method of claim 12, further comprising:
collecting, by the automatic inker fountain color detection and error correction device, data associated with the correcting the inker fountain color error and store the data in the memory.

19. The method of claim 12, further comprising:
forming a closed loop system between reading the ink colors from the images received the vision sensor and determining that the ink colors from the images satisfy recipe criteria without having to manually adjust inker fountains or inker keys.

20. The method of claim of 12, further comprising:
providing a color identification output that is uniformly and universally understood such that the color identification no longer relies on language or culture of an operator of the can decorator.
